(19) United States
(12) Patent Application Publication
(10) Pub. No.: US 2023/0201780 A1
(43) Pub. Date: Jun. 29, 2023

(54) PORTABLE CHEMICAL REAGENT MIXING DEVICE

(71) Applicant: Stephen Callender, St. Albans, NY (US)

(72) Inventor: Stephen Callender, St. Albans, NY (US)

(21) Appl. No.: 17/563,793

(22) Filed: Dec. 28, 2021

(51) Int. Cl. B01F 31/24; B01F 35/42; B01F 35/32; B01F 33/501

(52) U.S. Cl. CPC B01F 31/24; B01F 35/42; B01F 35/3204; B01F 33/5012; B01F 2101/22

(57) ABSTRACT

A portable chemical reagent mixing device is disclosed. The portable device has stabilizing guide rails to keep the chemical reagent pack in place. The device includes a mold holding a motor which has a gear at the top that presses against a gear contained at the side of a chemical reagent pack. A power source connects to the motor by electrical wires that can be secured and concealed in the base or platform of the invention. The invention has a back guard plate that houses an adjustable spring coil in place which helps secure the reagent pack in place so that the gear of the reagent pack is pressed against the gear attached to the top of the motor to agitate the contents of a chemical reagent pack to facilitate mixing.

### FIELD OF THE INVENTION

The present invention, a portable chemical reagent mixing device, is in the mechanical-electrical field and relates generally to a portable chemical reagent mixing device for mixing chemical reagents necessary for diagnostic testing. The present invention is an alternative to the laborious task of mixing chemical reagents by hand. In any given hospital or medical facility, medical personnel order laboratory testing on samples obtained from patients for analysis or diagnosis of various illness, diseases or to rule out suspected medical conditions. Most laboratories contain an instrument that performs chemical analysis on many different analytes including but not limited to Vitamin D, Chicken Pox, Measles, Mumps, and most recently coronavirus. The instrument uses several reagent packs that contain different chemical solutions in segregated compartments. The reagent packs must be mixed twice before putting into the instrument. Laboratory technologists are currently mixing the solution using their finger. The lab technologist must vigorously move his/her finger back and forth for about a minute twice—for two minutes total—to sufficiently agitate the solution. As such, there exists a need for a device that can automate the mixing process to meet the growing need for chemical analyses.

Aspects of embodiments of the present invention, contemplate a Portable Chemical Reagent Mixing Device which eliminates the time-consuming manual technique especially if there are multiple reagent packs being prepared for chemical analysis of patient samples. The present invention is also an alternative to the laborious task of mixing reagents by hand.

### SUMMARY OF THE PRESENT INVENTION

The portable chemical reagent mixing device is composed of a base or platform which can be made of wood, plastic, metal, or a combination of either one. The design consists of two stabilizing guide rails (composed of wood, plastic, or metal) to keep the reagent pack in place. The front of the device has a mold holding the motor which has a gear at the top that presses against a gear contained at the side of the reagent pack. The power source (either a battery pack or electrical 120volt power source) connects to the motor by electrical wires that can be secured and concealed in the base or platform of the invention. The invention has a back guard plate that houses an adjustable spring coil in place which helps secure the reagent pack in place so that the gear of the reagent pack is pressed against the gear attached to the top of the motor. The chemical reagent mixer will not only be innovative towards the future of comfort of an end user's function but also will change the chemical analysis industry as well the efficiency of lab technologists' preparation of reagents for laboratory analysis.

This portable chemical reagent mixing device is designed around chemical reagent packs, wherein the user may insert a chemical reagent pack within the groove within the guard rails of the apparatus and apply a power source which rotate the gear and engage the gear embedded in a chemical reagent pack to cause an agitation of the solution in the chemical reagent pack.

An aspect of an embodiment of the present invention contemplates a base or platform comprising of wood, plastic or a structurally solid material. These materials have been selected because they may be adapted or scaled to fit the needs and capacity of a chemical laboratory. Another aspect of an embodiment of the present invention contemplates stabilizing guide rails forming a groove within the base which will enclose the chemical reagent pack and secure it with a locking mechanism.

A further embodiment contemplates an adjustable spring coil and guard plate at the opposite end of the base or platform from the motor and gear which will serve as a guide and which will secure the reagent pack.

An aspect of an embodiment of the present invention contemplates an adjustable spring coil which may be adjusted to suit the length of the chemical reagent pack.

For a further and more fully detailed understanding of the present invention, various objects and advantages thereof, reference is made to the following detailed description and the accompanying drawings.

The foregoing and other objects and advantages will appear from the description to follow. In the description, references are made to the accompanying drawings, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWINGS

Further objectives and advantages of the present invention may be derived by referring to the detailed description and claims when considered in connection with the Figures, wherein like reference numbers refer to similar items throughout the Figures.

FIG. 1 illustrates a side view of a portable chemical reagent mixing device, according to an aspect of an embodiment of the present invention.

FIG. 2 illustrates a top view of a portable chemical reagent mixing device according to an aspect of an embodiment of the present invention.

### DETAILED DESCRIPTION OF THE PREFERRED EMBODIMENT

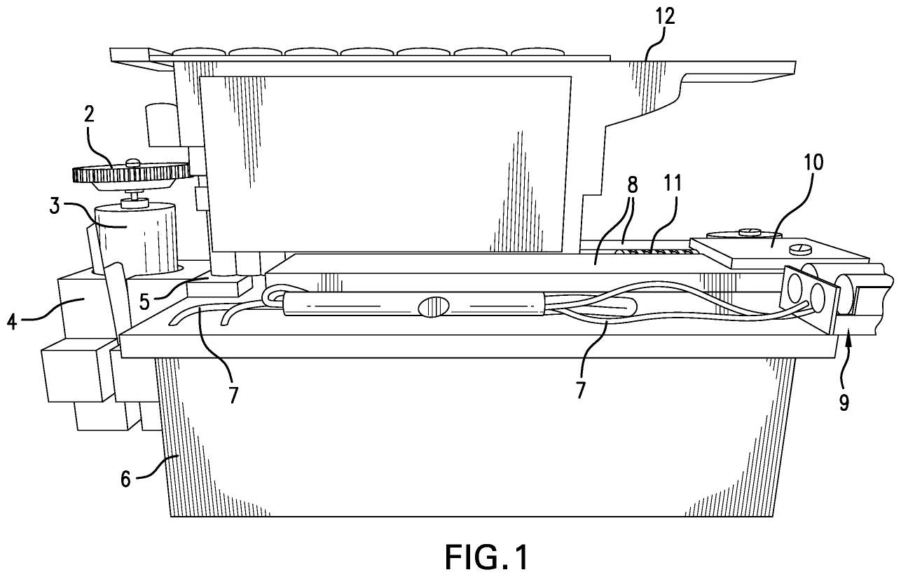

The following discussion describes in detail one embodiment of the system and method of the invention (and several variations of that embodiment). However, this discussion should not be construed as limiting the invention to those particular embodiments as practitioners skilled in the art will recognize numerous other embodiments as well. For definition of the complete scope of the invention, the reader is directed to appended claims. Turning now descriptively to the drawings, in which similar reference characters denote similar elements throughout the several views. Referring now to FIG. 1, a side view of a portable chemical reagent mixing device 1, is shown according to an aspect of an embodiment of the present invention, displaying the chemical reagent pack 12 enclosed in the device and attached to spur gear 2, said spur gear is connected to a motor 3, enclosed in a motor mound 4 comprised of stiff materials for support and to withstand heat that may be generated from the rotating tubular shaft, adjacent to an alignment guard 5 to secure and stabilize an enclosed chemical reagent pack 12, said spur gear 2 comprising a toothed wheel affixed to a rotating tubular shaft of the motor 3, electrical wires 7 connect a power source 9 to the motor and forms the basis of the current flow, passed through conductor in the wires inducing a magnetic field around the conductor, the conductor experiences a mechanical force causing the rotation of the tubular shaft within the motor which generates a rotational power and torque that turns the spur gear wherein the toothed wheel 2 interlocks with the grooves contained in a chemical reagent pack 12 behaving as a rack and pinion gear set which converts the rotation into linear motion to agitate the solution within the chemical reagent pack 12 to give it the level of mixing required; lateral stabilizing guide rails 8 create a track to secure the chemical reagent pack 12 and to align and hold the chemical reagent pack securely in place while the solution is being agitated, said track contains an adjustable spring coil 11 coil comprising of plastic, silicone or polypropylene snap rubber that secures and further stabilizes the chemical reagent pack 12 during the agitation process, said adjustable coiled spring is below a guard plate 10, which houses the adjustable spring coil and further stabilizes the chemical reagent pack, the guard plate is adjacent to a power source 9 in the form of a battery bank or an external power supply such as an adapter capable of supplying the necessary power to energize the entire circuit which when engaged (switched on) induces a magnetic field within the motor which then experiences a mechanical force powering the spur gear 2 to rotate the toothed wheel 2 to agitate the solution in the chemical reagent pack 12, a top a base platform structure 6 comprising of stiff materials constructed to support the elements of the device and to house the power source 8 and electrical wires 7 connected to the motor 3.

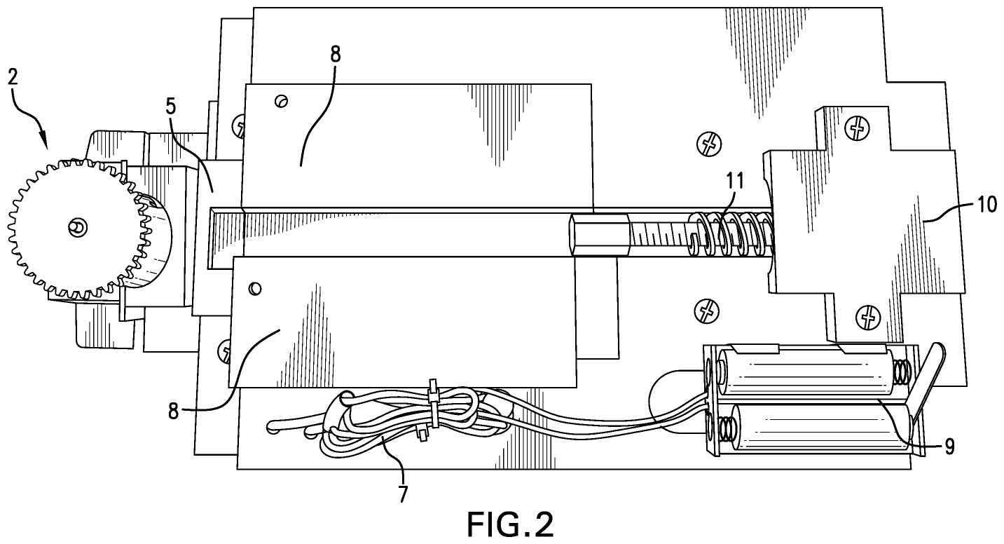

Referring now to FIG. 2, showing a top view of a portable chemical reagent mixing device 1, toothed wheel of the spur gear 2, adjacent to an alignment guard 5 to align and hold the chemical reagent pack securely in place while the solution is being agitated; electrical wires 7 connected to a power source 9 (open configuration), adjacent to a guard plate 10 housing an adjustable spring coil 11, lateral stabilizing guide rails 8.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

What is claimed is:

1. A portable chemical reagent mixing device for mixing chemical solution contained in a chemical reagent pack, the device comprising:
a base platform having a first end and a second end, wherein said second end is positioned opposite the first end along the same axis;
a spur gear comprising a toothed wheel, tubular shaft and motor;
lateral stabilizing guide rails forming a groove to house a chemical reagent pack;
a guard plate to secure and stabilize a chemical reagent pack;
an adjustable coiled spring to secure and stabilize a chemical reagent pack; and
a power source comprising electrical wires attached to a battery pack or adapter to generate a magnetic force to power said spur gear.

2. The portable chemical reagent mixing device recited in claim 1, wherein the base platform comprises of stiff materials constructed to support the elements of the portable mixing device.

3. The portable chemical reagent mixing device as recited in claim 1, wherein the spur gear comprises of a toothed wheel attached to a rotating tubular shaft enclosed in a motor mount wherein the motor mount comprises of a stiff material for support and to withstand heat that may be generated from the rotating tubular shaft.

4. The portable chemical reagent mixing device as recited in claim 1, wherein the lateral stabilizing guide rails are comprised of a material having a higher stiffness than the material of the platform.

5. The portable chemical reagent mixing device as recited in claim 1, wherein the adjustable coiled spring mechanism is comprised of plastic, silicone or polypropylene snap rubber.

6. The portable chemical reagent mixing device as recited in claim 1, further comprising an aligning guard rail affixed to the base platform between the motor mount and the grooves of the lateral stabilizing guide rails to align and secure a chemical reagent pack.

7. The portable chemical reagent mixing device as recited in claim 1, wherein the power source comprises of any one or more of: a battery pack or electrical wires connected to the motor to propel the spur gear to rotate the toothed wheel to agitate solutions contained in a chemical reagent pack.
